(19) United States
(12) Patent Application Publication
(10) Pub. No.: US 2013/0276441 A1
(43) Pub. Date: Oct. 24, 2013

(54) HYDRAULIC PUMP FOR CONSTRUCTION MACHINERY

(71) Applicants: Sang-Ki Bae, Changwon-si (KR); Jae-Hoon Lee, Changwon-si (KR); Sung-Yong Jo, Changwon-si (KR)

(72) Inventors: Sang-Ki Bae, Changwon-si (KR); Jae-Hoon Lee, Changwon-si (KR); Sung-Yong Jo, Changwon-si (KR)

(73) Assignee: VOLVO CONSTRUCTION EQUIPMENT AB, Eskilstuna (SE)

(21) Appl. No.: 13/996,055

(22) PCT Filed: Dec. 27, 2010
(86) PCT No.: PCT/KR2010/009352

§ 371 Date: Jun. 20, 2013

(51) Int. Cl. F15B 13/02; F15B 13/06

(52) U.S. Cl. CPC F15B 13/022; F15B 13/06
USPC 60/422; 91/531; 91/459

(57) ABSTRACT

Disclosed is a hydraulic pump for construction machinery for controlling to inhibit one-way driving when compound-operating two-way driving and work devices, such as a boom, to enhance operation efficiency. The hydraulic system for the construction machinery of the present invention provides the hydraulic system comprising: an operation device for driving and an operation lever for the work devices; a left driving motor which connects to a first hydraulic pump; a first control valve which is installed on the discharge flow path of the first hydraulic pump; a right driving motor which is connected to a second hydraulic pump; a hydraulic actuator which is connected to the first hydraulic pump and the second hydraulic pump; a second control valve which is installed on the discharge flow path of the first hydraulic pump or the second hydraulic pump; a third control valve which is installed on a flow path that branches from the discharge flow path of the second flow path; a first bypass valve which is connected to the upstream portion of the discharge flow path of the first hydraulic pump; a second bypass valve which is connected to the upstream portion of the discharge flow path of the second hydraulic pump; a confluence valve which is installed on a flow path which connects in parallel the discharge paths of the first and second hydraulic pumps; and a controller for controlling the opening of the first and second bypass valves and the confluence valve according to an operation signal that is input from the operation device for driving and the operation lever for the work device.

### FIELD OF THE INVENTION

The present invention relates to a hydraulic system for a construction machine, which includes a plurality of hydraulic pumps. More particularly, the present invention relates to a hydraulic system for a construction machine, in which when a combined operation of the two-way traveling operation and the operation of the work apparatus is performed, occurrence of a one-way traveling operation is prevented, thereby enhancing workability.

### BACKGROUND OF THE INVENTION

In general, in a hydraulic system for a construction machine such as an excavator including two or more hydraulic pumps, when a boom or an arm is actuated, a hydraulic fluid is simultaneously supplied to two hydraulic pumps in order to secure the driving speed of the work apparatus and enhance of the workability. In order to join the hydraulic fluids discharged from two hydraulic pumps, a confluence valve is mounted between the two hydraulic pumps to fluidically communicate the flow paths in which the two hydraulic pumps are mounted with each other. Thus, the flow rate of the hydraulic fluid is controlled based on the manipulation amount of a manipulation lever by a user so that the manipulability can be ensured.

In this case, a bypass valve installed in a discharge flow path of each hydraulic pump is controlled based on the manipulation amount of a manipulation lever by a user so that the manipulability can be ensured.

Meanwhile, a left traveling and a right traveling of the construction machine are performed by the hydraulic fluid supplied from each of the hydraulic pumps. In this case, the bypass valve is controlled based on the manipulation amount of a manipulation device by the user to ensure the manipulability. That is, for example, when a work of moving a heavy-weight clay pipe or a construction pipe material or a construction pipe material is performed, a two-way traveling and a work apparatus such as a boom or an arm are manipulated finely. In this case, even if the work apparatus is manipulated, a straight traveling must be carried out to easily perform the work.

In the meantime, in an excavator including a bypass valve, a confluence valve, and a load sensing valve, a combined operation is performed in which a left traveling operation and a right traveling operation are manipulated simultaneously with the operation of the work apparatus such as a boom or arm, the flow rate of the hydraulic fluid discharged from each of the hydraulic pump is decided depending on the work condition according to the two-way traveling operation and the operation of the work apparatus.

In other words, the hydraulic fluid from one-side hydraulic pump is supplied to the left traveling motor and the work apparatus when the manipulation lever of the work apparatus connected to the one-side hydraulic pump is manipulated, and simultaneously the hydraulic fluid from the other-side hydraulic pump is supplied to the right traveling motor and the work apparatus when the manipulation lever of the work apparatus connected to the other-side hydraulic pump is manipulated. In addition, the opening area of the bypass valve according to the manipulation of an operator is decided depending on the work condition according to the two-way traveling operation and the operation of the work apparatus.

Thus, when the operator manipulates the manipulation lever using the same manipulation amount as that in the two-way traveling operation to perform a straight traveling operation, and manipulates the boom or the arm to lift a heavy-weight object, the flow rate required for the two-way traveling operation is inputted to a flow rate control value of each hydraulic pump, and the flow rate according to the operation of the work apparatus such as the boom is inputted to a flow rate control value of a corresponding hydraulic pump.

Thus, since the flow rate required by the corresponding hydraulic pump according to the operation of the work apparatus is greater than that required by the hydraulic pump according to the traveling operation only, the discharge flow rate of each hydraulic pump varies. In addition, the opening area of a bypass valve manipulated for the traveling operation only and the opening area of a bypass valve manipulated for the operation of the work apparatus are made different from each other based on a concept such as calculation of the flow rate of the hydraulic pump.

Moreover, during the manipulation of the boom or arm, when the confluence valve for fluidically communicating the flow paths of both hydraulic pumps with each other are not completely opened when the manipulation amount of the boom or arm is small, leading to a pressure loss. As a result, the hydraulic fluid is not uniformly supplied to the left traveling motor and the right traveling motor, resulting in occurrence of a one-way traveling operation of the equipment.

### DETAILED DESCRIPTION OF THE INVENTION

### Technical Problems

Accordingly, the present invention was made to solve the aforementioned problem occurring in the prior art, and it is an object of the present invention to provide a hydraulic system for a construction machine in which when a combined operation of the two-way traveling operation and the operation of the work apparatus such as a boom is performed, the hydraulic fluids discharged from the hydraulic pumps are uniformly supplied to the left traveling motor and the right traveling motor, thereby preventing occurrence of a one-way traveling operation.

### Technical Solution

To accomplish the above object, in accordance with an embodiment of the present invention, there is provided a hydraulic system for a construction machine, which includes:

a manipulation device for traveling and a manipulation lever for a work apparatus that are configured to output manipulation signals in proportion to a manipulation amount;

first and second hydraulic pumps;

a left traveling motor connected to the first hydraulic pump and driven by the manipulation of a manipulation device 1 for left traveling;

a first control valve mounted in a discharge flow path of the first hydraulic pump and configured to control a start, a stop, and a direction change of the left traveling motor when it is shifted;

a right traveling motor connected to the second hydraulic pump and driven by the manipulation of the manipulation device for right traveling;

a hydraulic actuator connected to the first hydraulic pump or the second hydraulic pump, and driven by the manipulation of the manipulation lever for the work apparatus;

a second control valve mounted in a discharge flow path of the first hydraulic pump or the second hydraulic pump, and configured to control a start, a stop, and a direction change of the hydraulic actuator when it is shifted;

a third control valve mounted in a flow path branched from the discharge flow path of the second hydraulic pump and configured to control a start, a stop, and a direction change of the right traveling motor when it is shifted;

a first bypass valve connected to the upstream side of the discharge flow path of the first hydraulic pump and configured to be controlled in an opening amount based on the manipulation amount of the manipulation device for left traveling or the manipulation lever for the work apparatus;

a second bypass valve connected to the upstream side of the discharge flow path of the second hydraulic pump and configured to be controlled in an opening amount based on the manipulation amount of the manipulation device for right traveling or the manipulation lever for the work apparatus;

a confluence valve mounted in a flow path which connects the discharge flow paths of the first and second hydraulic pumps in parallel, and configured to be controlled in an opening amount based on the manipulation amount of the manipulation devices for traveling or the manipulation lever for the work apparatus; and

a controller configured to control the opening amounts of the first and second bypass valves and the confluence valve in response to the input of the manipulation signals of the manipulation devices for traveling and the manipulation lever for the work apparatus,

wherein when a combined operation of the two-way traveling and the work apparatus are performed, the opening areas of the first bypass valve and the second bypass valve are controlled to be equal to each other and the opening amount of the confluence valve is controlled to be the maximum.

According to a more preferable embodiment, the hydraulic system further includes:

an electronic proportional valve for the first bypass valve, which is configured to generate a signal pressure according to a control signal from the controller and apply the signal pressure to the first bypass valve to switch the valve;

an electronic proportional valve for the second bypass valve, which is configured to generate a signal pressure according to a control signal from the controller and provides the signal pressure to the second bypass valve to switch the valve; and

an electronic proportional valve for the confluence valve, which is configured to generate a signal pressure according to a control signal from the controller and provides the signal pressure to the confluence valve to switch the valve.

When the combined operation of the two-way traveling operation and the operation of the work apparatus is performed, the opening areas of the first and second bypass valves are controlled by the minimum value out of an opening area of the first bypass valve determined by calculating a left traveling manipulation amount and a work apparatus manipulation amount and an opening area of the second bypass valve determined by calculating a right traveling manipulation amount and a work apparatus manipulation amount.

The manipulation device for traveling includes the manipulation device for the left traveling that is configured to control the first control valve, and the manipulation device for the right traveling that is configured to control the third control valve.

The manipulation device for traveling is formed in a singular number and outputs the same value to the first control valve and the second control valve at the same time.

The manipulation device for traveling output an electric output value according to the manipulation.

The manipulation device for traveling outputs a hydraulic pressure according to the manipulation.

The manipulation lever for the work apparatus outputs an electric output value according to the manipulation.

The manipulation lever for the work apparatus outputs a hydraulic pressure according to the manipulation.

The electric output values of the manipulation device for traveling and the manipulation lever for the work apparatus are inputted into the controller, and the electronic proportional valves and for respectively converting the electric output values into hydraulic pressures to shift the first control valve, the second control valve, and the third control valve are mounted in the flow paths located between the controller and each of the control valves.

The manipulation amounts of the manipulation device for traveling and the manipulation lever for the work apparatus are detected by each of the pressure sensors (not shown) and inputted to the controller as the electric output values, and the pressure sensors are respectively mounted in the flow paths located between each of the manipulation devices and each of the first control valve, the second control valve, and the third control valve.

### Advantageous Effect

The hydraulic system for a construction machine in accordance with an embodiment of the present invention as constructed above has the following advantages.

When a combined operation of the two-way traveling operation and the operation of the work apparatus is performed, occurrence of a one-way traveling operation is prevented and thus a work is carried out according to an intention of an operator, thereby enhancing workability and safety owing to the improvement of manipulability.

### BRIEF DESCRIPTION OF THE INVENTION

The above objects, other features and advantages of the present invention will become more apparent by describing the preferred embodiments thereof with reference to the accompanying drawings, in which:

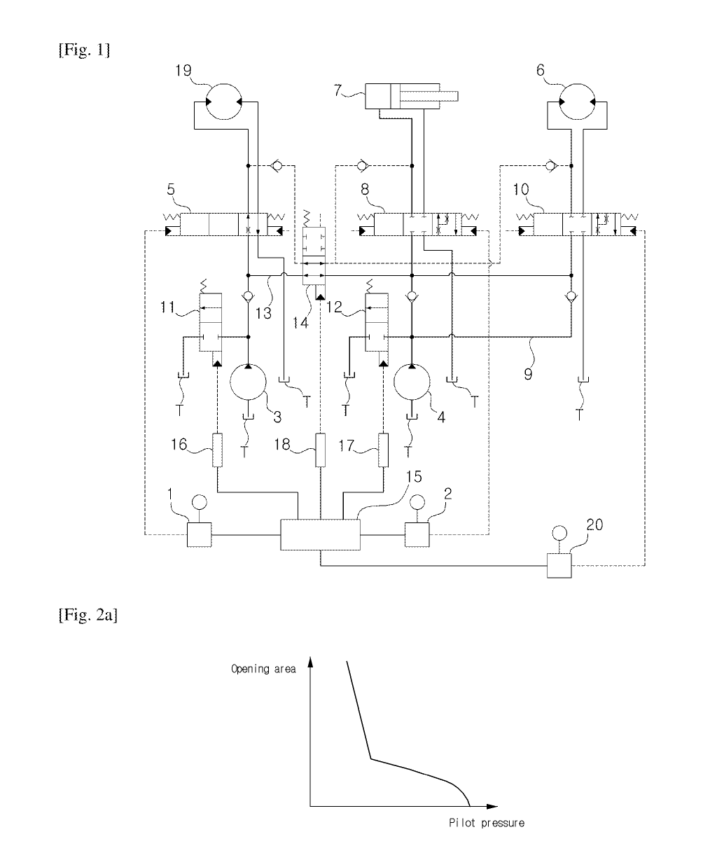

FIG. 1 is a circuit diagram showing a hydraulic system for a construction machine in accordance with the present invention;

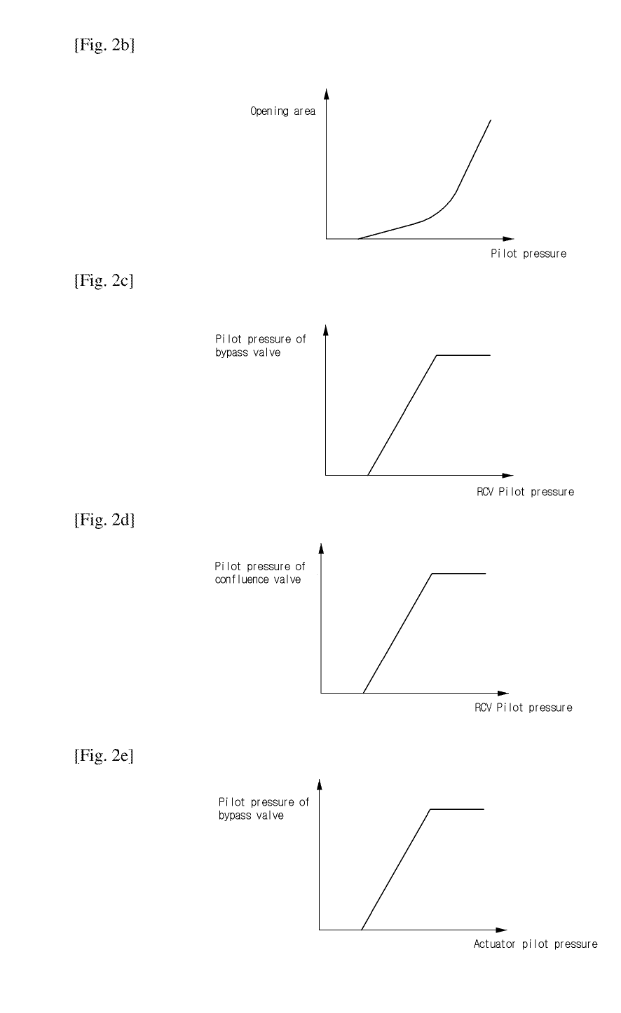

FIGS. 2(a) to 2(e) are graphs showing the control characteristics of a bypass valve and a confluence valve when a work apparatus is driven alone in a hydraulic system for a construction machine in accordance with an embodiment of the present invention; and

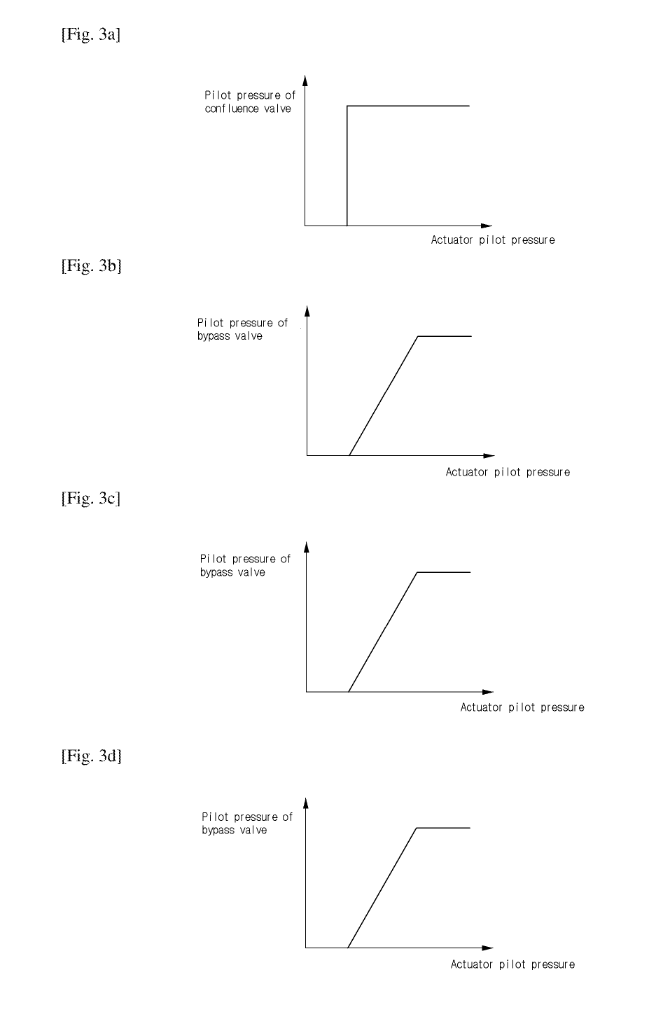

FIGS. 3(a) to 3(d) are graphs showing the control characteristics of the bypass valve and the confluence valve when a combined operation of the two-way traveling operation and the operation of the work apparatus is performed in a hydraulic system for a construction machine in accordance with an embodiment of the present invention.

### EXPLANATION ON REFERENCE NUMERALS OF MAIN ELEMENTS IN THE DRAWINGS

1: manipulation device for left traveling

2: manipulation lever for a work apparatus

3: first hydraulic pump

4: second hydraulic pump

5: first control valve

6: right traveling motor

7: hydraulic actuator

8: second control valve

9,13: flow path

10: third control valve

11: first bypass valve

12: second bypass valve

14: confluence valve

15: controller

16,17,18: electronic proportional valve

19: left traveling motor

20: manipulation device for right traveling

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

A hydraulic system for a construction machine in accordance with an embodiment of the present invention as shown in FIG. 1 includes:

a manipulation device 1 for left traveling (i.e., a left travel joystick), a manipulation device 20 for right traveling (i.e., a right travel joystick), and a manipulation lever 2 for a work apparatus, which are configured to output manipulation signals in proportion to a manipulation amount by an operator;

first and second hydraulic pumps 3 and 4 connected to an engine (not shown), respectively;

a left traveling motor 19 connected to the first hydraulic pump 3 and driven by the manipulation of a manipulation device 1 for left traveling;

a first control valve 5 (referring to a spool for the left traveling motor) mounted in a discharge flow path of the first hydraulic pump 3 and configured to control a start, a stop, and a direction change of the left traveling motor 19 when it is shifted by the manipulation of the manipulation device 1 for left traveling;

a right traveling motor 6 connected to the second hydraulic pump 4 and driven by the manipulation of a manipulation device 20 for right traveling;

a hydraulic actuator 7 (for example, a boom cylinder or the like) connected to the first hydraulic pump 3 or the second hydraulic pump 4, and driven by the manipulation of the manipulation lever 2 for the work apparatus;

a second control valve 8 (referring to a spool for the hydraulic actuator) mounted in a discharge flow path of the first hydraulic pump 3 or the second hydraulic pump 4, and configured to control a start, a stop, and a direction change of the hydraulic actuator 7 when it is shifted by the manipulation of the manipulation lever 2 for the work apparatus;

a third control valve 10 (referring to a spool for the right traveling motor) mounted in a flow path branched from the discharge flow path of the second hydraulic pump 4 and configured to control a start, a stop, and a direction change of the right traveling motor 6 when it is shifted by the manipulation of the manipulation device 20 for right traveling;

a first bypass valve 11 connected to the upstream side of the discharge flow path of the first hydraulic pump 3 and configured to be controlled in an opening amount based on the manipulation amount of the manipulation device 1 for left traveling or the manipulation lever 2 for the work apparatus;

a second bypass valve 12 connected to the upstream side of the discharge flow path of the second hydraulic pump 4 and configured to be controlled in an opening amount based on the manipulation amount of the manipulation device 20 for right traveling or the manipulation lever 2 for the work apparatus;

a confluence valve 14 mounted in a flow path which connects the discharge flow paths of the first and second hydraulic pumps 3 and 4 in parallel, and configured to be controlled in an opening amount based on the manipulation amount of the manipulation devices 1 and 20 for traveling or the manipulation lever 2 for the work apparatus; and

a controller 15 configured to control the opening amounts of the first and second bypass valves 11 and 12 and the confluence valve 14 in response to the input of the manipulation signals of the manipulation devices 1 and 20 for traveling and the manipulation lever 2 for the work apparatus, wherein when a combined operation of the two-way traveling and the work apparatus are performed, the opening areas of the first bypass valve 11 and the second bypass valve 12 are controlled to be equal to each other and the opening amount of the confluence valve 14 is controlled to be the maximum.

The hydraulic system further includes:

an electronic proportional valve 16 for the first bypass valve 11, which is configured to generate a signal pressure according to a control signal from the controller 15 and apply the signal pressure to the first bypass valve 11 to switch the valve;

an electronic proportional valve 17 for the second bypass valve 12, which is configured to generate a signal pressure according to a control signal from the controller 15 and provides the signal pressure to the second bypass valve 12 to switch the valve; and

an electronic proportional valve 18 for the confluence valve 14, which is configured to generate a signal pressure according to a control signal from the controller 15 and provides the signal pressure to the confluence valve 14 to switch the valve.

When the combined operation of the two-way traveling operation and the operation of the work apparatus is performed, the opening areas of the first and second bypass valves 11 and 12 are controlled by the minimum value out of an opening area of the first bypass valve 11 determined by calculating a left traveling manipulation amount and a work apparatus manipulation amount and an opening area of the second bypass valve 12 determined by calculating a right traveling manipulation amount and a work apparatus manipulation amount.

The manipulation device for traveling includes the manipulation device 1 for the left traveling that is configured to control the first control valve 5, and the manipulation device 20 for the right traveling that is configured to control the third control valve 10.

The manipulation device for traveling is formed in a singular number and outputs the same value to the first control valve 5 and the second control valve 8 at the same time.

The manipulation device 1 or 20 for traveling output an electric output value according to the manipulation.

The manipulation device 1 or 20 for traveling outputs a hydraulic pressure according to the manipulation.

The manipulation lever 2 for the work apparatus outputs an electric output value according to the manipulation.

The manipulation lever 2 for the work apparatus outputs a hydraulic pressure according to the manipulation.

The electric output values of the manipulation device 1 or 20 for traveling and the manipulation lever 2 for the work apparatus are inputted into the controller 15, and the electronic proportional valves 16, 17, and 18 for respectively converting the electric output values into hydraulic pressures to shift the first control valve 5, the second control valve 8, and the third control valve 10 are mounted in the flow paths located between the controller 15 and each of the control valves.

The manipulation amounts of the manipulation device 1 or 20 for traveling and the manipulation lever 2 for the work apparatus are detected by each of the pressure sensors (not shown) and inputted to the controller 15 as the electric output values, and the pressure sensors are respectively mounted in the flow paths located between each of the manipulation devices and each of the first control valve 5, the second control valve 8, and the third control valve 10.

In FIG. 1, a non-explained symbol T denotes a hydraulic tank.

Hereinafter, a use example of the hydraulic system for a construction machine in accordance with the present invention will be described in detail with reference to the companying drawings.

As shown in FIG. 1, in the case where an operator drives a work apparatus such as a boom or an arm of an excavator including two hydraulic pumps to perform a desired work, when the manipulation lever 2 for the work apparatus is manipulated by the operator, a spool of the second control valve 8 is shifted to the left on the drawing sheet in response to a pilot signal pressure supplied according to the manipulation of the manipulation lever 2. Thus, the hydraulic fluid supplied to the hydraulic actuator 7 from the second hydraulic pump 4 drives the hydraulic actuator 7 to cause the boom or the arm to be driven. Although the work apparatus is connected to the second hydraulic pump 4 in FIG. 1, it may be connected to the first hydraulic pump 3.

In this case, at an early stage of the work, the hydraulic fluid supplied to the hydraulic actuator 7 from the second hydraulic pump 4 drives the hydraulic actuator 7 to secure fine manipulability. Then, after the manipulation lever 2 for the work apparatus is manipulated to some extent, the hydraulic fluid is supplied to the hydraulic actuator 7 from the first hydraulic pump 3 to secure the operation speed of the work apparatus, rather than the fine manipulability.

In other words, the confluence valve 14 is shifted upwardly on the drawing sheet in response to a secondary signal pressure generated from the electronic proportional valve 18 for the confluence valve 14 so that the hydraulic fluid of the first hydraulic pump 3 can join the hydraulic fluid of the first hydraulic pump 4.

Meanwhile, the first bypass valve 11 connected to the discharge flow path of the first hydraulic pump 3 and the second bypass valve 12 connected to the discharge flow path of the second hydraulic pump 4 are controlled by the manipulation amounts of the manipulation devices 1 and 20 for traveling and the manipulation lever 2 for the work apparatus so that the manipulability can be secured.

FIGS. 2(a) to 2(e) are graphs showing the control characteristics of a bypass valve and a confluence valve when a boom or an arm of a work apparatus is driven in a hydraulic system for a construction machine in accordance with an embodiment of the present invention.

FIG. 2(a) shows the characteristics of an opening of the bypass valve. It can be seen from FIG. 2(a) that the opening areas of the first and second bypass valves 11 and 12 are decreased with an increase in the pilot pressure.

FIG. 2(b) shows the characteristics of an opening of the confluence valve. It can be seen from FIG. 2(b) that the opening area of the confluence valve 14 are increased with an increase in the pilot pressure.

FIG. 2(c) shows the control characteristics of the first bypass valve 11 connected to the discharge flow path of the first hydraulic pump 3. It can be seen from FIG. 2(c) that the pilot pressure supplied to the first bypass valve 11 is increased in proportional with a pilot pressure increased according to the manipulation amount of the manipulation device 1 for left traveling.

FIG. 2(d) shows the control characteristics of the confluence valve 14. It can be seen from FIG. 2(d) that the pilot pressure supplied to the confluence valve 14 is increased in proportional with a pilot pressure increased according to the manipulation amounts of the manipulation devices 1 and 20 for traveling and the manipulation lever 2 for a work apparatus.

FIG. 2(e) shows the control characteristics of the second bypass valve 12 connected to the discharge flow path of the second hydraulic pump 4. It can be seen from FIG. 2(e) that the pilot pressure supplied to the second bypass valve 12 is increased in proportional with a pilot pressure increased according to the manipulation amount of the manipulation device 20 for right traveling.

In case of the traveling operation, the left traveling motor 19 and the right traveling motor 6 are driven by the hydraulic fluids supplied thereto from the first hydraulic pump 3 and the second hydraulic pump 4, respectively. In this case, the first and second bypass valves 11 and 12 connected to the discharge flow paths of the first and second hydraulic pumps 3 and 4 are controlled based on the manipulation amounts of the manipulation device 1 for left traveling and the manipulation device 20 for right traveling so that the manipulability can be secured.

Meanwhile, in an excavator including a bypass valve, a confluence valve, and a load sensing valve, a combined operation can be performed in which the left traveling motor 19 and the right traveling motor 6 are driven by manipulating the manipulation device 1 for left traveling and the manipulation device 20 for right traveling, simultaneously the hydraulic actuator 7 is driven to operate the work apparatus such as the boom or the arm by manipulating the manipulation lever 2 for a work apparatus. In this case, the discharge flow rate of the first and second hydraulic pumps 3 and 4 are decided in consideration of the flow rate required depending on the combined operation of the two-way traveling operation and the operation of the work apparatus.

In other words, the hydraulic fluid discharged from the first hydraulic pump 3 is supplied to the left traveling motor 19 and the hydraulic fluid discharged from the second hydraulic pump 4 is supplied to the right traveling motor 6 and the hydraulic actuator 7 for work apparatus, respectively.

As described above, when the combined operation of the two-way traveling operation and the operation of the work apparatus is performed by manipulating the manipulation devices for traveling and the manipulation lever for work apparatus, a control signal from the controller 15 is applied to the electronic proportional valve 18 for the confluence valve 14 to cause a secondary signal pressure according to the applied control signal to be applied to the confluence valve 14 so that a spool built in the confluence valve is shifted upwardly on the drawing. In this case, the confluence valve 14 is controlled to be opened to the maximum so that the hydraulic fluid discharged from the first hydraulic pump 3 joins the hydraulic fluid discharged from the second hydraulic pump 4.

Simultaneously, a control signal from the controller 15 is applied to the electronic proportional valve 16 for the first bypass valve 11 to cause a secondary signal pressure according to the applied control signal to be applied to the first bypass valve 11 so that a spool built in the first bypass valve 11 is shifted upwardly on the drawing. In addition, a control signal from the controller 15 is applied to the electronic proportional valve 17 for the second bypass valve 12 to cause a secondary signal pressure according to the applied control signal to be applied to the second bypass valve 12 so that a spool built in the second bypass valve 12 is shifted upwardly on the drawing.

In this case, the opening areas of the first and second bypass valves 11 and 12 are controlled to be equal to each other. Further, when the combined operation of the two-way traveling operation and the operation of the work apparatus is performed, the opening areas of the first and second bypass valves 11 and 12 are controlled by the minimum value out of an opening area of the first bypass valve 11 determined by calculating a left traveling manipulation amount and a work apparatus manipulation amount and an opening area of the second bypass valve 12 determined by calculating a right traveling manipulation amount and a work apparatus manipulation amount.

As such, when the combined operation of the two-way traveling operation and the operation of the work apparatus is performed by manipulating the manipulation devices for traveling and the manipulation lever for work apparatus, the confluence valve 14 are opened to the maximum to cause the hydraulic fluid discharged from the first hydraulic pump 3 to join the hydraulic fluid discharged from the second hydraulic pump 4. In addition, the spools built in the fires and second bypass valves 11 and 12 are shifted so that the opening areas of the first and second bypass valves 11 and 12 are equal to each other. Thus, the hydraulic fluid discharged from the first hydraulic pump 3 joins the hydraulic fluid discharged from the second hydraulic pump 4, and the flow rates of the hydraulic fluids bypassed from the first and second bypass valves 11 and 12 are also equal to each other, and thus occurrence of a one-way traveling operation is prevented.

FIGS. 3(a) to 3(e) are graphs showing the control characteristics of the bypass valve and the confluence valve when a combined operation of the two-way traveling operation and the operation of the work apparatus such as a boom or an arm is performed in a hydraulic system for a construction machine in accordance with an embodiment of the present invention.

FIG. 3(a) shows the control characteristics of the confluence valve 14. It can be seen from FIG. 3(a) that the pilot pressure supplied to the confluence valve 14 is increased vertically in proportional with a pilot pressure increased according to the manipulation amounts of the manipulation devices 1 and 20 for traveling and the manipulation lever 2 for a work apparatus.

FIG. 3(b) shows the control characteristics of the first bypass valve 11 connected to the discharge flow path of the first hydraulic pump 3. It can be seen from FIG. 3(b) that the pilot pressure supplied to the first bypass valve 11 is increased in proportional with a pilot pressure increased according to the manipulation amount of the manipulation device 1 for left traveling.

FIG. 3(c) shows the control characteristics of the second bypass valve 12 connected to the discharge flow path of the second hydraulic pump 4. It can be seen from FIG. 3(c) that the pilot pressure supplied to the second bypass valve 12 is increased in proportional with a pilot pressure increased according to the manipulation amount of the manipulation device 20 for right traveling.

FIG. 3(d) shows the control characteristics of the first and second bypass valves 11 and 12 connected to the discharge flow path of the first and second hydraulic pumps 3 and 4. It can be seen from FIG. 3(d) that the pilot pressure supplied to the first and second bypass valves 11 and 12 is increased in proportional with a pilot pressure increased according to the manipulation amounts of the manipulation devices 1 and 20 for traveling and the manipulation lever 2 for a work apparatus.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, in the hydraulic regeneration system for a construction machine in accordance with an embodiment of the present invention, when a combined operation of the two-way traveling operation and the operation of the work apparatus such as a boom is performed, the hydraulic fluids discharged from the hydraulic pumps are uniformly supplied to the left traveling motor and the right traveling motor, thereby preventing occurrence of a one-way traveling operation, and thus enhancing workability and safety owing to the improvement of manipulability.

1. A hydraulic system for a construction machine comprising:
a manipulation device for traveling and a manipulation lever for a work apparatus that are configured to output manipulation signals in proportion to a manipulation amount;
first and second hydraulic pumps;
a left traveling motor connected to the first hydraulic pump and driven by the manipulation of a manipulation device for left traveling;
a first control valve mounted in a discharge flow path of the first hydraulic pump and configured to control a start, a stop, and a direction change of the left traveling motor when it is shifted;
a right traveling motor connected to the second hydraulic pump and driven by the manipulation of a manipulation device for right traveling;
a hydraulic actuator connected to the first hydraulic pump or the second hydraulic pump, and driven by the manipulation of the manipulation lever for the work apparatus;
a second control valve mounted in a discharge flow path of the first hydraulic pump or the second hydraulic pump, and configured to control a start, a stop, and a direction change of the hydraulic actuator when it is shifted;
a third control valve mounted in a flow path branched from the discharge flow path of the second hydraulic pump and configured to control a start, a stop, and a direction change of the right traveling motor when it is shifted;
a first bypass valve connected to the upstream side of the discharge flow path of the first hydraulic pump and configured to be controlled in an opening amount based on the manipulation amount of the manipulation device for left traveling or the manipulation lever for the work apparatus;
a second bypass valve connected to the upstream side of the discharge flow path of the second hydraulic pump and configured to be controlled in an opening amount based on the manipulation amount of the manipulation device for right traveling or the manipulation lever for the work apparatus;
a confluence valve mounted in a flow path which connects the discharge flow paths of the first and second hydraulic pumps in parallel, and configured to be controlled in an opening amount based on the manipulation amount of the manipulation devices for traveling or the manipulation lever for the work apparatus; and
a controller configured to control the opening amounts of the first and second bypass valves and the confluence valve in response to the input of the manipulation signals of the manipulation devices for traveling and the manipulation lever for the work apparatus,
wherein when a combined operation of the two-way traveling and the work apparatus are performed, the opening areas of the first bypass valve and the second bypass valve are controlled to be equal to each other and the opening amount of the confluence valve is controlled to be the maximum.

2. The hydraulic system according to claim 1, wherein when the combined operation of the two-way traveling operation and the operation of the work apparatus is performed, the opening areas of the first and second bypass valves are controlled by the minimum value out of an opening area of the first bypass valve determined by calculating a left traveling manipulation amount and a work apparatus manipulation amount and an opening area of the second bypass valve determined by calculating a right traveling manipulation amount and a work apparatus manipulation amount.

3. The hydraulic system according to claim 1, further comprising:
an electronic proportional valve for the first bypass valve, which is configured to generate a signal pressure according to a control signal from the controller and apply the signal pressure to the first bypass valve to switch the valve;
an electronic proportional valve for the second bypass valve, which is configured to generate a signal pressure according to a control signal from the controller and provides the signal pressure to the second bypass valve to switch the valve; and
an electronic proportional valve for the confluence valve, which is configured to generate a signal pressure according to a control signal from the controller and provides the signal pressure to the confluence valve to switch the valve.

4. The hydraulic system according to claim 1, wherein the manipulation device for traveling comprises: the manipulation device for the left traveling that is configured to control the first control valve; and the manipulation device for the right traveling that is configured to control the third control valve.

5. The hydraulic system according to claim 1, wherein the manipulation device for traveling is formed in a singular number and outputs the same value to the first control valve and the second control valve at the same time.

6. The hydraulic system according to claim 4, wherein the manipulation device for traveling outputs an electric output value according to the manipulation.

7. The hydraulic system according to claim 4, wherein the manipulation device for traveling outputs a hydraulic pressure according to the manipulation.

8. The hydraulic system according to claim 1, wherein the manipulation lever for the work apparatus outputs an electric output value according to the manipulation.

9. The hydraulic system according to claim 1, wherein the manipulation lever for the work apparatus outputs a hydraulic pressure according to the manipulation.

10. The hydraulic system according to claim 1, wherein the electric output values of the manipulation device for traveling and the manipulation lever for the work apparatus are inputted into the controller, and the electronic proportional valves for respectively converting the electric output values into hydraulic pressures to shift the first control valve, the second control valve, and the third control valve are mounted in the flow paths located between the controller and each of the control valves.

11. The hydraulic system according to claim 1, wherein the manipulation amounts of the manipulation device for traveling and the manipulation lever for the work apparatus are detected by each of the pressure sensors and inputted to the controller as the electric output values, and the pressure sensors are respectively mounted in the flow paths located between each of the manipulation devices and each of the first control valve, the second control valve, and the third control valve.
